(19) United States
(12) Patent Application Publication
(10) Pub. No.: US 2011/0293808 A1
(43) Pub. Date: Dec. 1, 2011

(54) HANDHELD RAPID COOLING DEVICE FOR FOOD

(76) Inventor: Kevin Fleming, Kansas City, MO (US)

(21) Appl. No.: 13/116,232

(22) Filed: May 26, 2011

Related U.S. Application Data
(60) Provisional application No. 61/396,389, filed on May 26, 2010.

(51) Int. Cl. A23L 1/00

(52) U.S. Cl. 426/524; 99/517

(57) ABSTRACT

The present invention relates to a handheld device for quickly cooling hot foods and method for using the device to cool hot foods. In particular, the device is comprised of a vessel, a base that is removably attached to the bottom open end of the vessel and a nozzle affixed through the base. The device is configured to hold frozen elements and receive air through the open top end of the vessel. The air becomes chilled as it flows through the frozen elements and exits the device through the nozzle which is positioned over the hot foods, allowing a user to quickly and easily cool hot foods prior to consumption.

### CROSS REFERENCE TO RELATED APPLICATION

This application claims priority from U.S. Provisional Application Ser. No. 61/396,389, filed on May 26, 2010, which is hereby incorporated by reference in its entirety.

### FIELD OF THE INVENTION

The present invention relates to a novel handheld food cooling device suitable for quickly and easily cooling hot foods prior to consumption and a method for using the device to cool hot foods. In particular, the device is configured to hold frozen elements, such as ice, in a hollow interior cavity, while the top of the device is configured to receive the lips of the user. When the user blows air into the device, the air passes through the frozen elements, chills, and then exits the device through a small aperture or hole located in the bottom of the device. When the user holds the device over the hot foods, the chilled air is precisely directed onto hot foods thereby reducing the temperature of the foods so they can easily and safely be consumed.

### BACKGROUND

Food prepared at home or in a restaurant can be too hot for safe and immediate consumption by people, especially children and handicapped or elderly adults who are usually unable to adequately cool hot foods themselves.

There are a variety of methods currently employed by people to cool plated hot foods to a safe temperature for consumption. These methods include, among others, allowing hot food to sit at room temperature for a period of time, blowing air onto hot food from one's mouth, fanning the food with one's hand, placing an ice cube into liquid-based foods to dissipate the heat, and placing hot food into a refrigerator or freezer until cooled to a safe temperature for consumption. However, these methods can be problematic in addition to time consuming. For example, blowing on hot food can inadvertently contaminate the food, while placing ice into or onto hot food can dilute the flavor. In addition, placing hot food into a refrigerator or freezer is not easily accomplished when dining in a restaurant or at an outside location and leaving the food in freezer or refrigerator for too long can over chill the food. Accordingly, there is a need for a handheld rapid cooling device that can be used anywhere by anyone for cooling hot foods quickly without contaminating them or diluting the flavor.

The prior art describes numerous devices for keeping food and drinks cool over long periods of time. These portable cooler-type containers or freeze-pack devices, such as those described in U.S. Pat. Nos. 4,441,336, 4,688,395, 5,875,646, 6,128,915, and 6,851,274, may be suitable for the particular purpose to which they address, but would not be as suitable for the purposes of the present invention, which is to quickly decrease the temperature of hot foods for safe and immediate consumption.

Several devices to assist people in cooling hot food for safe and immediate consumption have been provided in the prior art. For example, U.S. Publication No. 2008/0274250 describes an apparatus for cooling food items within an inner space of a rotatable cylinder. The cylinder comprises a cooling device that is filled with a cryogenic liquid which cools the food as it rotates around the cylinder. The shortcomings of this device is that it is not easily portable and would be dangerous for small children and elderly or handicapped adults to use due to the inclusion of a cryogenic liquid. In addition, U.S. Publication No. 2009/0090251 describes a portable food cooling device comprising a cover which is placed over a plate of hot food. The cover includes an electric fan installed at the dome of the cover that cools the food. The shortcomings of this device are that it is not easily portable if eating outside of the home and the blades of the fan could be dangerous for small children when the fan is in operation.

Therefore, there still remains a need in the art for a food cooling device that is simple to use, inexpensive, portable, quick, and safe.

### SUMMARY OF THE INVENTION

A principal objective of the present invention is to provide a handheld device for quickly cooling hot foods so that they may be safely eaten by children without burning the insides of their mouths, lips, or fingers. A related objective of the invention is to provide a device for quickly cooling hot food without contaminating it. Additional objectives and advantages of the present invention will become apparent to persons skilled in the art from the detailed description considered along with the accompanying claims and drawings.

The food cooling device of the present invention preferably comprises a handheld vessel that includes an open top end and an open bottom end. The configuration of the vessel is designed to receive ice or frozen units. The open top end is preferably configured to receive the lips of a user while the open bottom end is configured to receive and communicate with a removable base. The removable base includes at least one hole. The hole may additionally include a nozzle, which nozzle perpendicularly intersects the base. The nozzle may be removably or permanently secured to the interior of the base by a fastener.

The present invention further provides for a method of using the food cooling device to quickly reduce the temperature of hot foods for safe and enjoyable consumption. The method preferably comprises the steps of placing frozen elements into the vessel of the device, holding the device over hot food, placing one's mouth over the open top end of the device, exhaling air in strong bursts into the open top end of the device, chilling the blown air as it passes through the ice placed in the vessel, and cooling the hot food as the chilled air, which is directed at the hot foods, exits the hole or nozzle that is included in the base of the device.

### BRIEF DESCRIPTION OF DRAWINGS

The accompanying drawings illustrate embodiments of the invention and are for illustration by way of example and not limitations.

FIG. 1 is a perspective view of the device filled with ice in use;

FIG. 2 is a perspective view of the device filled with ice in accordance with the present invention;

FIG. 3 is a perspective view of the empty device;

FIG. 4 is a top plan view of the device;

FIG. 5 is a side plan view of the device;

FIG. 6 is a bottom plan view of the device; and

FIG. 7 is an exploded perspective view of the device.

### DETAILED DESCRIPTION

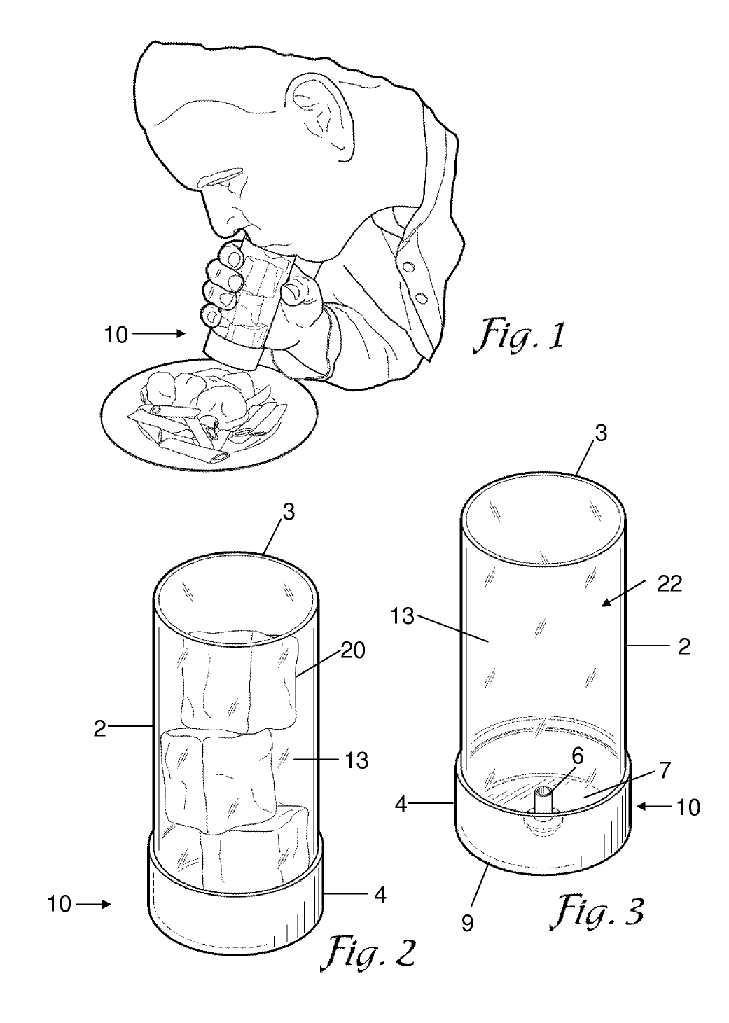

A food cooling device 10 is depicted in FIGS. 1-7. As illustrated in FIG. 7, the device 10 comprises a vessel 2 with an open top end 3 and an open bottom end 5. The vessel 2 can be fabricated from any food safe durable material known in the art. Preferably, the vessel 2 is made from a material selected from the group consisting of, but not limited to, plastic, rubber, polymers, wood, metal, minerals, and combinations thereof. Plastic is especially preferred. In an additional embodiment the vessel can include insulative material to retain the cooling nature of the ice while in use. The vessel 2 can be of any size and shape suitable to be grasped by a human hand, such as for example a cylinder, cone, sphere, rectangular prism, or triangular prism. In a preferred embodiment, the vessel 2 has a cylindrical shape. In an additional embodiment the vessel can include double walled insulated side walls creating the walls of the vessel. The exterior of the vessel 2 can be smooth as shown in the preferred embodiment in FIGS. 1-7, or alternatively, the exterior of the vessel 2 can comprise a handhold mechanism selected from the group consisting of grooves, a slip resistant coating, handles, or grippers enabling the device 10 to be securely and easily held in one's hand.

The vessel 2, as best seen in FIGS. 2 and 3, comprises a hollow interior cavity 13 created by the wall 22 of the vessel. The hollow interior cavity as illustrated in FIG. 2 is designed to hold any type of frozen element 20 known in the art. Preferably, the frozen element 20 is selected from the group consisting of ice, reusable ice cubes, ice packs, coolant agent, evaporator coils, and combinations thereof. In a preferred embodiment, the frozen element 20 is ice cubes as shown in FIG. 2.

In a preferred embodiment, the open top end 3 of the vessel is configured to receive the lips of a user, as illustrated in FIG. 1. In an alternative embodiment, the open top end 3 of the vessel 2 comprises a lid that includes a protrusion for placement into or onto a user's mouth. The protrusion may be for example, a spout, straw, or any other type of structure that is designed to receive air from one's mouth or through mechanical means.

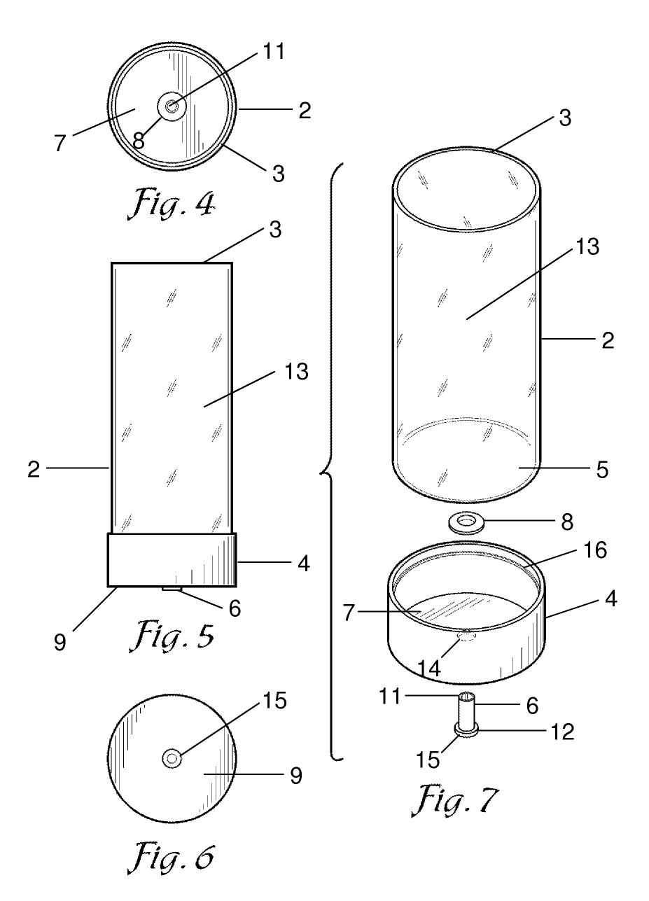

As illustrated in FIGS. 3, 5, and 7, a base 4 is preferably attached to the open bottom end 5 of the vessel 2 in either a permanent or removable manner. Attachment of the base 4 to the open bottom end 5 of the vessel 2 seals off the open bottom end 5 of the vessel 2 so as to form a receptacle from the hollow interior cavity to hold the frozen element 20. One of ordinary skill in the art would recognize that a base attached to the open end of the device is not specifically required and having a closed bottom end of the vessel 2 would perform the same function as a base. Thus an additional embodiment is a vessel with an open top end and a closed bottom end configured from a single piece of material. As shown in the figures, the base 4 is preferably attached in a removable manner to the open bottom end 5 of the vessel 2 through any secure locking engagement known in the art, including but not limited to, a seal, threading mechanism, o-ring, friction, snap fit mechanism, or combinations thereof. In one embodiment, the base 4 is removably secured to the open bottom end 5 of the vessel 2 through use of an O-ring 16, as illustrated in FIG. 7. The base 4 can be of any height, but preferably is shorter than the length of the vessel 2, as shown in FIG. 5. As illustrated in FIGS. 4-7, the base is comprised of an inner surface 7 and an exterior bottom 9. The exterior bottom 9 of the base 4 is preferably flat as illustrated in FIG. 5 enabling the device 10 to stand upright when placed on a surface.

The base 4 further comprises at least one aperture 14 as shown in FIG. 7. In alternative embodiments, the base comprises a plurality of apertures. The aperture may additionally include a nozzle 6, as shown in FIG. 7. In a preferred embodiment, the base comprises a single nozzle 6. In alternative embodiments, the base comprises a plurality of nozzles. The nozzle 6 can be fabricated from any durable material known in the art. Preferably, the nozzle 6 is made from a material selected from the group consisting of, but not limited to, plastic, rubber, polymers, metal, and combinations thereof. In a preferred embodiment, the nozzle 6 is made from plastic. The nozzle 6 comprises a top end 11 and a bottom end 12. The length of the nozzle 6 is preferably shorter than the height of the base 4 and the diameter of the nozzle 6 is preferably smaller than the open top end 3 of the vessel 2. FIG. 6 illustrates the nozzle 6 extending through the aperture 14 of the base 4 to the bottom of the device 10. As illustrated in FIG. 4, the top end 11 of the nozzle 6 extends upward from the inner surface 7 of the base 4, while FIG. 6 shows the bottom end 12 of the nozzle 6 extending downward from the exterior bottom 9 of the base 4.

In alternative embodiments wherein the device comprises a closed bottom end instead of a base, the closed bottom end comprises at least one aperture and may additionally comprise at least one nozzle.

As shown in FIGS. 6 and 7, the bottom end 12 of the nozzle 6 may additionally comprise a rim 15 having a larger diameter than that of the top end 11. The rim 15 of the nozzle 6 ensures that water and/or saliva that collects in the base 4 of the vessel 2 is not transferred to the foods being cooled.

As shown in FIGS. 3 and 7, the nozzle 6 is inserted into the base 4 through the aperture 14 and is held in fixed or removable connection with the base 4 by friction, threading mechanism, a fastener, or ring, or snap fit mechanism. Preferably, the nozzle 6 is held in removable connection with the base 4 by a fastener 8, which may be any type known in the art. In alternative embodiments, the nozzle is held in removable connection with the closed bottom end of the vessel by a fastener. In a preferred embodiment, the fastener 8 comprises a washer as illustrated in FIG. 7. The fastener 8 may be made from any material known in the art. Preferably, the fastener 8 is made from a material selected from the group consisting of, but not limited to, plastic, rubber, metal, polymers, and combinations thereof. In addition to securing the nozzle 6 to the base 4 of the vessel 2, the fastener also acts to “pool” any water or condensation that may drip from the frozen element 20, and saliva that may be excreted from the user's mouth, so that the liquids are trapped inside the bottom of the vessel 2 and are not transferred onto the foods being cooled. FIG. 4 illustrates the nozzle 6 removably secured to the base 4 by the fastener 8 as viewed through the open top end 3 of the vessel 2. The removable attachment of the nozzle 6 to the base 4 allows the device 10 to be easily disassembled for cleaning.

A method for using the food cooling device 10 to cool hot foods is also disclosed. The method generally includes filling the device 10 with frozen elements 20 and blowing air through the top of the device. FIG. 1 provides an illustration of how the device 10 is designed to be used to reduce the temperature of hot foodstuffs situated on a plate in accordance with the present invention. The device 10 is first filled with enough frozen elements 20 to fill the inner hollow cavity of the vessel 2 but still allow air to flow through. Next, a user holds the device 10 in their hand and positions it over the foods desired to be cooled. In a preferred embodiment, the user places their mouth over the open top end 3 of the device 10 and generates airflow into the device 10 by blowing air into the device through their mouth. In another embodiment, the user places an electric or pumped encourager of airflow over the open top end 3 of the device 10. Blowing the air into the device 10 through the frozen elements 20 produces chilled air. The chilled air then exits the device 10 through the nozzle 6 affixed to the base 4 and is directly focused onto the foods to be cooled quickly resulting in a reduction of temperature in the hot foods. The device 10 can be easily disassembled by removing the base 4 from the open bottom end 5 of the vessel 2 to clean and dry after each use.

The device 10 of the present invention is preferably used to cool hot foods that have been placed on a dish. The term “dish” refers to various vessels of different shapes that are used for holding hot food including but not limited to, plates, saucers, bowls, trays, and vessels made from ceramic, glass, plastic, metal, or composite materials. The shape of the dish is not limited for use of the present invention and may include circular, square, rectangular, oval, or any other shape dish as may be provided.

Thus, a food cooling device 10 and method of using have been described. It is apparent to those skilled in the art, however, that many changes, variations, modifications, other uses, and applications to the device and method for using are possible, and also such changes, variations, modifications, other uses, and applications which do not depart from the spirit and scope of the invention are deemed to be covered by the invention, which is limited only by the claims which follow.

1. A handheld device for cooling food, the device comprising:
a. a vessel comprising an open top end configured to receive the lips of a user and closed bottom end; and
b. the closed bottom end comprising at least one aperture,
wherein air is forced into the open top end from the user and exits the at least one aperture in the closed bottom end.

2. The device of claim 1, wherein the closed bottom end further comprises a nozzle extending through the at least one aperture.

3. The device of claim 2, further comprising a fastener for securing the nozzle to the closed bottom end.

4. The device of claim 1, wherein the vessel is made from plastic.

5. The device of claim 1, wherein the vessel further comprises a handhold mechanism selected from the group consisting of grooves, a slip resistant coating, handles, grippers, or combinations thereof.

6. The device of claim 1, wherein the vessel in configured to hold frozen elements.

7. The device of claim 8, wherein the frozen elements are ice.

8. The device of claim 1, wherein the open top end further comprises a lid configured to receive the lips of a user.

9. A handheld device for cooling food, the device comprising:
a. a vessel comprising an open top end configured to receive the lips of a user and an open bottom end;
b. a base attached to the open bottom end of the vessel, wherein the base comprises at least one aperture;
wherein air is forced into the open top end and exits the at least one nozzle in the base.

10. The device of claim 9, wherein the base is removably attached to the vessel using an attachment mechanism selected from the group consisting of a threading mechanism, a snap fit mechanism, friction, or combinations thereof.

11. The device of claim 9, wherein the base is permanently affixed to the vessel.

12. The device of claim 9, wherein the base further comprises at least one nozzle extending through the at least one aperture.

13. The device of claim 12, wherein the base further comprises a fastener for securing the nozzle to the at least one aperture in the base.

14. A method of using a handheld device for cooling foods comprising the steps of:
a. filling the device with frozen elements, wherein the device comprises a vessel comprising an open top end configured to receive the lips of a user, an open bottom end, and a base attached to the open bottom end of the vessel, wherein the base comprises at least one aperture;
b. positioning the at least one aperture of the base over the foods;
c. placing one's lips over the open top end of the device;
d. blowing air into the open top end of the device;
e. passing the air through the frozen elements to produce chilled air;
f. releasing the chilled air through the nozzle; and
g. contacting the foods with the chilled air released through the nozzle.
